(19) United States
(12) Patent Application Publication
(10) Pub. No.: US 2014/0278865 A1
(43) Pub. Date: Sep. 18, 2014

(54) Systems and Methods for Direct Distribution of Merchant-Based Rewards

(71) Applicants: Anush KUMAR, Mercer Island, WA (US); Arvind SRINIVASAN, Mercer Island, WA (US); Steve ROSEN, Mercer Island, WA (US); Naman SINGHAL, Mercer Island, WA (US); James ALLARD, Mercer Island, WA (US)

(72) Inventors: Anush KUMAR, Mercer Island, WA (US); Arvind SRINIVASAN, Mercer Island, WA (US); Steve ROSEN, Mercer Island, WA (US); Naman SINGHAL, Mercer Island, WA (US); James ALLARD, Mercer Island, WA (US)

(73) Assignee: SPLASHCO, INC., Mercer Island, WA (US)

(21) Appl. No.: 14/206,263

(22) Filed: Mar. 12, 2014

Related U.S. Application Data
(60) Provisional application No. 61/777,359, filed on Mar. 12, 2013.

(51) Int. Cl. G06Q 30/02; G06Q 50/00

(52) U.S. Cl. CPC G06Q 30/0214; G06Q 50/01
USPC 705/14.16

(57) ABSTRACT

Systems and methods of the invention relate to directly distributing an offer from a merchant to a user based on a relationship established via the Internet. More specifically, the user can request and/or accept a relationship with an entity in which such relationship is leveraged by the merchant to either directly communicate an offer to such user and/or directly communicate an offer to such user and one or more relationships associated with such user. Moreover, based on the one or more relationships redeeming or using the offer, the user can be provided with a specific offer and/or an offer customizable to his or her preferences within one or more guidelines from the merchant.

### CROSS-REFERENCE TO RELATED APPLICATIONS

This application claims the benefit of U.S. Provisional Application Ser. No. 61/777,359, filed Mar. 12, 2013, and entitled “SYSTEMS AND METHODS FOR DIRECT DISTRIBUTION OF MERCHANT-BASED REWARDS.” The entirety of the aforementioned application is incorporated herein by reference.

### BACKGROUND

1. Technical Field

Embodiments of the subject matter disclosed herein relate to directly distributing an offer to a user for use within a store (e.g., physical store, online presence related to a store, website, and the like).

2. Discussion of Art

Coupons and advertisements provide consumers with discounts or special offers at particular stores or services. Conventional techniques often rely on a strategy that entails distributing large quantities of coupons or advertisements to as many individuals as possible. However, these conventional technique are typically inefficient and ineffective since ideal target consumers are a small percentage of the many individuals that received the coupon or advertisement.

It may be desirable to have a system and method that differs from those systems and methods that are currently available.

### BRIEF DESCRIPTION

In an embodiment, a method is provided that includes at least the following steps: establishing a relationship between a user and a merchant via at least one of a request or an existing relationship of the user from at least one social network; receiving an offer from the merchant based upon the established relationship; communicating the offer to one or more relationships of the user; and receiving an additional offer from the merchant based upon one or more redemptions of the offer communicated to the one or more relationships of the user.

In an embodiment, a method is provided that includes at least the following steps: accepting a request to establish a relationship with a user via at least one of an automatic acceptance from a relationship between the user and a merchant or a direct request from a user to the merchant; communicating an offer from the merchant to the user based upon the accepted relationship; monitoring a communication of the offer from the user; tracking a number of redemptions from at least one of the user or the one or more relationships of the user; and communicating an additional offer from the merchant exclusive to the user based upon the tracked number of redemptions.

In an embodiment, a system can be provided that includes at least one of a device, a merchant component, a user component, and/or a device for a user. In another embodiment, the system can further include a business analytics component. In another embodiment, systems and/or methods allow creation of a reward from a merchant to which a user can redeem in order to receive a benefit from the merchant when redeemed by the user and/or an additional user that has an online relationship with the user. In an embodiment, a method can be provided that includes at least the following steps: creating an offer from a merchant based on media; communicating the offer to one or more users; associating a reward to the offer, wherein the reward relates to the merchant; and communicating the reward to at least one user based on redemption, wherein the communication is a user that redeemed the offer or an additional user that has an established relationship on a social network.

In another embodiment, a method is provided that includes at least the following steps: receiving an incentive from a provider, wherein the provider is a restaurant; identifying an ambassador relationship between the provider and an ambassador user; transmitting the incentive to the ambassador user; receiving an incentive action from a prospect user, the prospect user shares at least a prospect relationship with the ambassador user; and crediting an ambassador score associated with the ambassador user based at least in part on the incentive action.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for directly distributing a splash pass to a user (e.g., brand ambassador) based on a relationship;

FIG. 2 is an illustration of an embodiment of a system for analyzing data related to a splash pass or a redemption of a splash pass;

FIG. 3 is an illustration of an embodiment of a system interacting with a store in accordance with the subject innovation;

FIG. 4 is an illustration of an embodiment of a system for distribution of a splash pass;

FIG. 5 illustrates a flow chart of an embodiment of a method for receiving a splash pass;

FIG. 6 illustrates a flow chart of an embodiment of a method for communicating a splash pass;

FIG. 7 illustrates a screen shot in accordance with the subject innovation;

FIG. 8 illustrates a screen shot in accordance with the subject innovation;

APPENDIX A is a document that describes aspects of the claimed subject matter, and this Appendix forms part of this specification; and

APPENDIX B is a document that describes aspects of the claimed subject matter, and this Appendix forms part of this specification.

### DETAILED DESCRIPTION

Embodiments of the invention relate to methods and systems for directly distributing an offer from a merchant to a user (e.g., consumer) based on a relationship established via the Internet. More specifically, the user can request and/or accept a relationship with an entity (e.g., business, service, company, store, among others) in which such relationship is leveraged by the merchant to either directly communicate an offer to such user and/or directly communicate an offer to such user and one or more relationships (e.g., connections, links, followers, social network relationships, and the like) associated with such user (based on the user's discretion). Moreover, based on the one or more relationships redeeming or using the offer, the user can be provided with a specific offer and/or an offer customizable to his or her preferences within one or more guidelines from the merchant. The subject innovation allows a merchant to directly communicate one or more offers to users that are invested (e.g., have a relationship with, are a brand ambassador, that have an interest in the merchant, that have an interest in the goods, that have an interest in the services, and the like) in the merchant or entity and provides rewards or incentives for a user to expose an offer to others (e.g., friends of the user's social circle, relationships based off of the user, and the like) who redeem such offers. In another embodiment, the innovation allows a merchant to directly communicate one or more offers to users that are invested in the merchant or entity and may provide (e.g., at the merchant's discretion) rewards or incentives for a user to expose an offer to others (e.g., friends of the user's social circle, relationships based off of the user, and the like) who redeem such offers.

With reference to the drawings, like reference numerals designate identical or corresponding parts throughout the several views. However, the inclusion of like elements in different views does not mean a given embodiment necessarily includes such elements or that all embodiments of the invention include such elements.

The term “component” as used herein can be defined as a portion of hardware, a portion of software, or a combination thereof. A portion of hardware can include at least a processor and a portion of memory, wherein the memory includes an instruction to execute.

The term “merchant” as used herein can be defined as a business, a service, a company, a store, a website, an entity that sells goods or services, or an employee of an entity that sells good or services, among others. In a particular example, a merchant can include an entity (e.g., business, company, store, website, and the like) that provides at least one of the following: sell a food item; deliver a food item; provide a catering; sell culinary services; distribute food; and the like. For instance, a merchant can be a restaurant that sells food, delivers food, provides catering, or serves food.

The term “splash” or “splashed” as used herein can be defined as an act of communicating an offer (e.g., coupon, coupon code, sale price, sale price for item or service, reduction of price for a service or good, online offer, in-store offer, and the like) from a merchant, wherein the communication can be from a merchant to one or more users, from a user to one or more relationships, among others. “Splash” or “splashed” can be used herein as a verb in which an act of sharing via a network, a social network, the Internet, email, messaging, among others.

The term “brand ambassador” as used herein can be defined as a user with a relationship (e.g., user requested relationship that is accepted by merchant, merchant requested relationship accepted by user, following from a social network, connection via a website, connection via a social network, connection via a social media channel, among others) with a merchant.

The term “splash pass” as used herein can be defined as an offer redeemable at an entity or with a merchant, wherein the splash pass is from a merchant or representative of the merchant based on a relationship or subscription to the store (e.g., established online via website, application, widget, social network, social media channel, and the like). The splash pass can be received by a brand ambassador or one or more users that have a relationship with the brand ambassador. For instance, the splash pass can be splashed from the merchant to the brand ambassador and/or the splash pass can be splashed from a brand ambassador to one or more relationships of the brand ambassador from one or more social networks (e.g., website, application, and the like).

The term “splash group” as used herein can be defined as one or more relationships of a brand ambassador that can receive a splash pass. The splash group can be a customizable listing of users connected (e.g., having a relationship) to the brand ambassador through one or more social media channels (e.g., website, social network, subscription feed, and the like).

The term “splash feed” as used herein can be a defined as a live stream of data (e.g., text, images, audio, video, and the like) related to one or more splash passes from one or more merchants to a brand ambassador or a user. The splash feed can be a source for information related to a merchant, a splash pass, a status of a splash, a status of a splash loop, among others.

The term “sponsored splash pass” as used herein can be defined a splash pass sponsored by a 3^{rd} party entity while still being administered by the merchant. The splash pass can be endorsed or include an advertisement from a disparate merchant in comparison to the merchant splashing the splash pass.

The term “splash loop” as used herein can be defined as a merchant defined number of customers that redeem a splash pass, wherein a brand ambassador that reaches the defined number of customers from their respective one or more relationships completes the splash loop and, in turn, a customizable splash pass (e.g., user splashes) from the merchant.

The term “user splashes” as used herein can be defined as a brand ambassador customized splash pass that is defined with one or more restrictions from a merchant. The user splashes can be communicated to the brand ambassador from a merchant as a reward for completing a splash loop. In another embodiment, the term “user splashes” as used herein can be defined as a portion of media from a user communicated to a merchant of which the merchant accepts and converts the portion of media into a splash pass. The term “user splashes” can include a “splashtag” that is a tag (e.g., data tag, metadata tag, among others) that corresponds a communication of a portion of media from the user. In an example, the splathtag is a hashtag that is communicated with media or content from a user to a website, a database, a server, a web service, among others. For instance, a splashtag can be associated with a video or photo from a user in which the user can communicate such video or photo to a website, wherein a merchant can register to receive splashtags related (e.g., redeemable from or acceptable at) to such merchant. Based upon receipt or a query result received from the merchant, the video or photo that are associated with the splashtag can be used by the merchant to create a splashpass to the brand ambassador or a plurality of brand ambassadors (e.g., users that have a relationship with the merchant).

The term “splash pass campaign” as used herein can be defined as at least one splash pass communicated to one or more brand ambassadors characterized by at least one of a good or service the splash pass is directed, the merchant that created the splash pass, a geographic location for the splash pass, among others.

FIG. 1 is an illustration of a system 100 for directly distributing a splash pass to a user (e.g., also referred to as a brand ambassador) based on a relationship. The system 100 can include a merchant component 102 that is configured to create at least one of a splash pass, a splash pass campaign, a user splash, splashtag, among others. A merchant (not shown but discussed below) can create a splash pass via a device 104 that can be communicated to a user 110 (also referred to as a brand ambassador), wherein the user is a brand ambassador for the merchant. The creation of a splash pass can originate from rich-media (e.g., photos, video, and the like) that a merchant self-generates or creates from a user-splash. The brand ambassador 110 can receive the splash pass and perform at least one of the following via a device 108: redeem the splash pass at a physical location related to the merchant; or splash (e.g., publish, post, communicate, etc.) the splash pass to a network of connections (e.g., users with a relationship to the brand ambassador on one or more social networks). In an embodiment, a user can capture media (e.g., photo, video, and the like), tag it with the Splashtag (usually denoted by ‘#[merchantname]’), to communicate to a merchant in which the merchant can determine or decide whether to convert the media into a splash pass. In such embodiment, the merchant can control offers to users but also get an insight on what consumers may desire or prefer from the merchant.

A user component 106 can be configured to receive one or more splash passes from one or more merchants based upon a subscription or relationship with said one or more merchants. The user component 106 can be employed to identify merchants, request to be a brand ambassador for a merchant, splash a splash pass, identify a splash pass, locate a merchant, browse splash passes, view relationships with merchants or friends, configure social network linkage (e.g., synchronize contacts, identify connections, among others).

In an embodiment, the device 108 can include a global positioning service component (not shown) that is configured to provide a geographic location for the device 108 and, in turn the user 110. In another embodiment, the device 108 can include geographic positioning components that utilize a cellular signal and/or Wi-Fi connection to determine an approximate geographic location. The user component 106 can leverage the geographic location of the device 108 and/or the user 110 to communicate a splash pass or a merchant that offers a splash pass. Additionally, the merchant component 102 can ascertain geographically proximate users that, based upon security setting(s), can receive solicited splash passes by verified merchants or approved merchants.

In an embodiment, the merchant component 102 can implement a media-to-commerce technique in which a merchant can transform media to a splash pass in a stream-lined manner without excessive steps, settings, or configurations. Turning to FIG. 7, a screenshot 700 illustrates media-to-commerce (e.g., photo-to-commerce, video-to-commerce, among others). The screenshot 700 illustrates that a merchant can capture (via an input based on one or more icons 702) a campaign photo (or media such as video, a portion of video, a screenshot, an audio clip, and the like) that is to be used with a created splash pass (e.g., offer). The photo or media (e.g., the input such as, a user input on an icon displayed by the device, a voice command, a movement, a hand gesture, etc.) can be taken in real time from the device, uploaded from a previously taken media, user-generated content (e.g., user-splashes), from the Internet (e.g., screen shot, captured audio, captured photo, downloaded video, uploaded video, link, website, a portion of copied text, a portion of user entered text, among others), and the like. The screenshot 700 further illustrates a text box 704 that allows the merchant to insert a description for at least one of the media, the splash pass, user-generated content (e.g., photos or videos with Splashtags), terms (e.g., expiration, limits per person, etc.). The screenshot 700 can also include a preview input and/or a publish input, wherein the preview input provides a preliminary view or preview of the splash pass prior to publication or sending to users. Additionally, the publish input can be used to communicate the splash pass or offer to one or more users.

Turning to FIG. 8, a screenshot 800 is illustrated which depicts selection of media, wherein the selection is based on an input detected as discussed in FIG. 7 above. It is to be appreciated that although the screenshot includes text that says “Photo,” that any suitable media can be implemented with the subject disclosure such as, but not limited to, text, audio, video, live feeds, and the like. In general, the screenshot 800 can be used by a merchant as an overview or manager of activity related to splash passes, campaigns, photos, or videos with Splashtags, and the like. The screenshot 800 includes a “My Photos” section 802 that are media captured or stored on the device for the merchant. The screenshot 800 further includes a “User Splashes” section 804 that are media from users tagged with splashtags. The screenshot 800 can further includes “Tagged Photos” section 806 that can be media that has been tagged or associated with a merchant (e.g., merchant directly, merchant good, merchant service, among others). The tag or association can be a hashtag (e.g., #), a metadata tag, among others.

In an embodiment, the hashtag (e.g., media with Splashtags or tagged media through 3^{rd} party applications or websites such as, for example, INSTAGRAM™, in which the application or website can allow a merchant to reward or thank consumers directly with a splash pass at the merchant's discretion). Thus, a merchant is capable of rewarding consumers, benefit business, and create stronger ties to loyalty therebetween (e.g., between merchant and consumers). Moreover, as discussed above, a merchant can gauge an interest or identify a unique splash pass from the consumer directly.

It is to be appreciated that the device 104 and/or the device 108 can be any suitable computing device that can communicate and/or transmit data via a network. For example, the device 104 and/or the device 108 can be, but is not limited to, a portable gaming device, a smartphone, a cellular device, a tablet, a desktop computer, a computer, a personal computer, a portable digital assistant (PDA), a laptop, a phablet (e.g., a smartphone and tablet), a gaming console, a wearable computing device (e.g., smart watch, a pair of glasses that communicate data, wearable technology, etc.), a wireless communication device, a desktop machine, a portable device, a computing device, a device that can access the Internet, a device that includes memory, a processor and a wireless component to transmit and/or receive data, and the like. It is to be appreciated that the merchant component 102 can be a stand-alone component (as depicted), incorporated into the device 104, or a combination thereof. It is to be appreciated that the user component 106 can be a stand-alone component (as depicted), incorporated into the device 108, or a combination thereof.

Although not depicted in FIG. 1, it is to be appreciated that in an embodiment the merchant component 102 can be a stand-alone component (as depicted), incorporated into a social network (not illustrated but discussed in FIG. 2), incorporated into a cloud-based service, or a suitable combination thereof. Similarly, it is to be appreciated that in an embodiment the user component 106 can be a stand-alone component (as depicted), incorporated into a social network (not illustrated but discussed in FIG. 2), incorporated into a cloud-based service, or a suitable combination thereof.

FIG. 2 is an illustration of a system 200 for analyzing data related to a splash pass or a redemption of a splash pass. The system 200 can include a business analytics component 202 that can be configured to monitor, track, collect, and/or analyze data related to the system 200 and/or the system 100. The business analytics component 202 can be accessed by a brand ambassador (e.g., user), a merchant, or a user associated with the merchant). The system 200 illustrates a merchant or a user associated with the merchant utilizing the business analytics component 202 with the device 104. It is to be appreciated that the business analytics component 202 can be a stand-alone device (as depicted), incorporated into the device 104, incorporated into a social network 204, or a suitable combination thereof.

In particular, the business analytics component 202 can allow a merchant and/or user to customize variables or data to collect and/or evaluate. For instance, specific data can be identified and tracked to provide a user with insight on a certain splash pass or portion of a splash pass campaign. In an embodiment, the business analytics component 202 can be customized with functions, formulas, equations, and the like to calculate figures or quantities. For example, a set of data can be collected in which an efficiency can be calculated. In another example, a social capital and/or an impact of a user's network can be calculated.

The business analytics component 202 can provide at least one of the following: number of splash passes (e.g., number of splash passes distributed, services/goods the splash passes related, redemption rate of splash passes, tracking of how a splash pass got to be redeemed, track of the hand-offs of the splash pass, number of splash passes redeemed, and the like); data related to brand ambassadors (e.g., age, sex, other merchants that he/she is being a brand ambassador, location, information from a social network, which social networks the user is enrolled, occupation information, education information, number of relationships or connections, and the like); type of splash pass (e.g., percentage off, buy one get one free, type of marketing strategy for the splash pass, type of advertising layout for the splash pass, among others); splash pass data (e.g., which service/good the offer relates, terms of the offer, content of the offer, target of splash pass consumers, marketing target for the splash pass campaign, costs savings of offer in splash pass, cost of the good or service related to the splash pass, among others); monetary data related to the splash pass (e.g., cost saved by redemption from users, cost of new sales from the splash pass, number of increase sales related to splash pass, historical sales data, comparison data related to sales with and/or without splash pass, among others); predictive data (e.g., prognostic data related to prediction of redemption for a particular user with a particular splash pass based on user data and/or splash pass data, geographic proximity targeted splash pass, identification of demographic for potential consumer, criteria common across brand ambassadors, criteria common across brand ambassadors with a high redemption rate, among other), number of customers acquired, and the like.

The business analytics component 202 can be further utilized to facilitate creating customized data collection profiles of one or more users, wherein the customization is based on a definition of the data from a merchant. For instance, the data collection profile can be used to evaluate data to increase sales (e.g., to one or more users) of a good or service associated or provided by the merchant. For example, the business analytics component 202 can infer which portions of data to collect and evaluate for one or more users based on user data (e.g., age, location, type of purchase, type of payment, name, and the like) and a splash campaign or splash pass. For instance, based on collected user data from one or more users (e.g., customers or potential customers that visited the merchant in person or via the web) and the splash campaign used or not used, the business analytics component 202 can evaluate a success of such splash campaign or which splash campaign can be created to replicate such sale or customer traffic. The business analytics component 202 can further evaluate splash campaigns to identify which are more successful (e.g., more traffic that translates into actual sales) for a particular group of user data. For instance, a first portion of user data can be determined to be more likely to purchase using a first splash campaign and a second portion of user data can be determined to be more likely to purchase using a second splash campaign. In such instance, a first age group can be determined to be more likely to purchase using a first splash campaign and a second age group can be determined to be more likely to purchase using a second splash campaign. It is to be appreciated that any suitable number of splash campaigns can be used with any suitable selection of user data.

The business analytics component 202 can employ value of information (VOI) computation in order to identify splash campaigns targeted to a particular user or users for a merchant. For instance, by utilizing VOI computation, the most ideal splash campaign can be identified and exposed for a specific user. Moreover, it is to be understood that the business analytics component 202 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, X3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

It is to be appreciated that the social network 204 can be, but is not limited to being, a website or application that allows a user to perform at least one of the following: a subscription to a user; a request to connect to a user; an acceptance to a request to connect; a following of a user; a follower of a user; among others. Moreover, the social network 204 can be a suitable website or web service in which one or more users can interact with one another in which content distribution or access is restriction based upon a relationship, wherein the relationship is an acceptance or agreement on such relationship via a request between at least two users. For instance, a relationship can be a connection, a friend, a follower, a following, among others. By way of example and not limitation, the social network 204 can be, but is not limited to, FACEBOOK™, TWITTER™, LINKEDIN™, PINTEREST™, YOUTUBE™, INSTAGRAM™, VINE™, among others.

The social network 204 can be a website, an application, a widget, a web service, among others, that is configured to enable a user to distribute data (e.g., text, media, among others) to other users or to view/receive data from other users based on at least one of membership to such social network 204 or an acknowledgement between two users. For instance, the acknowledgement can be a request from one user that is accepted by another user. In another example, a setting can be an automatic acceptance of a user request unless the user later decides blocks or rejects. In an example, a user can be followed without approval unless the user decides to block the follower within the social network 204. Within the social network 204, a user can include one or more relationships or connections, wherein each relationship or connection indicates an acknowledgement between two users. The social network 204 can include feeds (e.g., news feeds, status updates, changes to user data, picture notifications, new posts from users, etc.), posts from users (e.g., status change, new pictures, new media, new geographic location, etc.), lists of connections (e.g., friends, circles of friends, connections, subscribed channels, followers, etc.), likes (e.g., pages, companies, stores, items, that the user designates as having an interest, etc.), among others. It is to be appreciated that there can be a suitable number of social networks such as social network₁ to social network_{N}, where N is a positive integer.

The social network 204 and related data for a respective user can be leveraged by the system 100 and/or 200 in order to identify merchants to which a brand ambassador can be requested. For instance, if user A on a social network has posted about merchant B, then such information can be leveraged in order to request user A to be a brand ambassador for merchant B. In another instance, user A may “like” or subscribe to merchant B (e.g., subscribe to social network, mailing list, etc.) in which case user A can be automatically enrolled as a brand ambassador for merchant B (based on acceptance by user A). It is to be appreciated that the relationships and data from the social network 204 can be leveraged and utilized to glean at least one of potential suitors (e.g., brand ambassadors) for a merchant, content for a splash pass, good or service to send to brand ambassador for a splash pass, geographic location for a targeted splash pass, among others.

In an embodiment, the merchant component (not shown), the user component (not shown) and/or the business analytics component 202 stores information related to the systems 100, 200, 300, and/or 400, components of the specific systems 100, 200, 300, and/or 400 with a data store 206. It is to be appreciated that there can be any suitable number of data stores. The data store 206 can include information such as, but not limited to, business analytic data (discussed above), brand ambassador data, splash pass data, merchant information, social network data, settings, security data, configuration data, splash loop data, splash feed data, splash group data, statistics (e.g., brand ambassador redemption rate, connections, relationships, etc.), among others, and/or a suitable combination thereof.

It is to be appreciated that the data store 206 can be, for example, either volatile memory or nonvolatile memory, or can include both volatile and nonvolatile memory. The data store 206 of the subject systems and methods is intended to comprise, without being limited to, these and other suitable types of memory. In addition, it is to be appreciated that the data store 206 can be a server, a database, a hard drive, a flash drive, an external hard drive, a portable hard drive, a cloud-based storage, and the like.

FIG. 3 is an illustration a system 300 interacting with a store in accordance with the subject innovation. The system 300 can include the Internet 302 that allow communication between the device 104 and at least one of the merchant component 102, the store 304, and/or the user component 106. In another embodiment, the Internet 302 provides communicative support between the device 108 and at least one of a user, the user component 106, the merchant component 102, the store 304. Further, the store 304 can be, but is not limited to being, a physical store (e.g., brick and mortar store), a website for the store, an online application for the store, a combination thereof, among others. For instance, a brand ambassador for a merchant (e.g., merchant for the store 304) can receive an offer (e.g., splash pass) and redeem such splash pass (e.g., or one or more relationships can redeem the splash pass) at the store 304, wherein the store 304 is a physical location or a website or online checkout for the store 304. In an embodiment, the splash pass can utilize at least one of a code (e.g., a portion of text, a letter, a number, a combination thereof), a password (e.g., a word, a number sequence, or a combination thereof), a bar code, a proximity sensor, Radio Frequency Identification (RFID) technology, Near-Field Communication (NFC), BLUETOOTH™, wireless technology, short messaging service (SMS), text messages, push messages, a Quick Response (QR) code, among others in order to communicate and authenticate the redemption of the splash pass. In another embodiment, the transmission of the redemption of the splash pass can be via a scan (by the merchant) of an image, wherein the image includes data representative of the splash pass.

FIG. 4 is an illustration of a system 400 for distribution of a splash pass. The system 400 includes a splash pass 402 that is created by a merchant 401. The splash pass 402 can be communicated by the merchant 401 to one or more brand ambassadors (e.g., brand ambassador 404, brand ambassador 408), wherein there can be a suitable number of brand ambassadors such as brand ambassador₁ to brand ambassador_{M} with M being a positive integer. Each brand ambassador can be subscribed to or a member to one or more social networks in which each social network can include respective relationships. For instance, brand ambassador 404 can include social networks 406 and brand ambassador 408 can include social networks 410. It is to be appreciated that the brand ambassador 404 can include a suitable number of social networks 406 such as social network₁ to social network_{P}, where P is a positive integer. It is to be appreciated that the brand ambassador 408 can include a suitable number of social networks 410 such as social network₁ to social network_{Q}, where Q is a positive integer.

The following provides an overview related to various embodiments of the subject disclosure. It is to be appreciated that the below embodiments are solely for example and not to be seen as limiting on the subject innovation. In an embodiment, the merchant component 102, the user component 106, and/or a combination thereof can provide the following features and elements.

Merchant-Side Interactions

A merchant side interaction can include at least one of the following: login or portal through social media application, website, or social network (e.g., FACEBOOK™, TWITTER™, LINKEDIN™, PINTEREST™, YOUTUBE™, INSTAGRAM™, VINE™, social network with list of one or more users that interact via the Internet, social media channels, and the like), wherein the login or portal can be with, for instance, an account user name and/or password; account creation; merchant's campaign creation and management (e.g., creation, modification, and execution which can include a one-click photo to splash pass feature); utilizing one or more dashboards for monitoring campaign execution (e.g., discussed in more detail below in Business Analytics); integration with one or more social media applications (e.g., FACEBOOK™, TWITTER™, MYSPACE™, LINKEDIN™, PINTEREST™, YOUTUBE™, INSTAGRAM™, VINE™, among others) for publishing a splash pass, a message, and the like.

The campaign creation and execution via the merchant component 102 can place a merchant in control of providing exclusive splash passes to brand ambassadors (e.g., users) to share with their friends (e.g., connections on a social network, followed users on a social network, subscription to a user on a social network, among others). Specifically, these interactions can include at least one of the following: single-click photo from a device (e.g., device 104) to a splash pass (e.g., going from a photo taken to posting an splash pass (e.g., exclusive offer) for one or more brand ambassadors subscribed to the merchant or social channel associated with the merchant (e.g., FACEBOOK™, TWITTER™, LINKEDIN™, PINTEREST™, YOUTUBE™, INSTAGRAM™, VINE™, website, social website, social network, among others) and/or a splash feed on the device (e.g., device 108); or a sponsored Splash pass which can be a variation of the splash pass and is sponsored by a 3^{rd} party entity while still being ‘self-administered’ by the merchant. In an embodiment, the following can be performed by the merchant component 102: take a picture that related to the exclusive offer being made available to a brand ambassador and/or friends of a brand ambassador (e.g., directed or communicated to such friends via the brand ambassador); provide descriptive details (e.g., splash pass validity, number of passes available that can be claimed, offer details, fine print, legal terms, conditions, terms of agreement, and the like); or post (e.g., publish, communicate, and the like) to at least one brand ambassador or a select set of users. For instance, the post can be to at least one of a website, a social network, a social media channel, an inferred group of users that are determined to be interested in the splash pass based on data gleaned by the business analytics component 202 and/or a recommended user list based on the learning of the systems from prior similar campaigns (e.g., splash pass campaigns or usage) that the merchant has used (e.g., historic data). Creation can also encompass using user-generated content (e.g., photos or videos with Splashtags), photos (e.g., media on a social network, pictures, and the like) that have hashtags (e.g., #<merchant brand name>).

User-Side Interactions

Users can be segregated into a brand ambassador or brand ambassador's friends (e.g., a connection on a social network, a follower on a social network, a relationship on a social network or website, a subscription to a user on a website or network, and the like). A brand ambassador can claim or redeem a splash pass from a merchant (based upon subscribing to the merchant to create a relationship) and splash (e.g., resend the splash pass) from the merchant they are following. Additionally, the brand ambassador can splash the splash pass received to their immediate relationships (e.g., friends, connections, followers, friend circles, among others). Friends of a brand ambassador can claim and redeem a splash pass but are not able share with their friends. In another embodiment, friends of a brand ambassador can claim and redeem a splash pass and are able to share with their friends.

User interaction with the user component 106 can include at least one of the following: login through to the user component 106 and/or via a social network, website, or social media channel, wherein the login can be with an account management; set and/or modify a profile (e.g., splash group modification, receipt of a splash pass, who to splash to, settings for notification, geographic settings, location settings, and the like); follow merchants via search and/or wish-list configuration (e.g., send request to merchant to entice merchant to initiate a splash pass campaign); claim (e.g., accept a splash pass from a merchant that is limited in quantity for instance), splash (e.g., communicate or publish), and/or redeem a splash pass; monitor splash feed for friend's splash activity and/or nearby merchant splash activity; view and/or act on user's splash page (e.g., merchants followed, actionable passes that are available by expiry, category, or location); view and/or act on push notifications (e.g., alerts or notifications); or a SplashTag that can be a bonus splash (upon completion of a splash loop).

In embodiment, a creation of splash groups can be provided by the user component 106 in which the user 110 can create and/or modify default groups of friends (e.g., relationships) to share splash passes with (e.g., share with one friend, share with all friends, share with a set of friends that are in a particular location, etc.). In an embodiment, splashing a pass can be exclusively to friends or specific splash groups only (e.g., for claiming and redemption). In an embodiment, the subject innovation can include a wish-list configuration or component that allows the user 110 to express interest in a merchant who is has not communicated a splash pass or does not have a brand ambassador (e.g., the user can be designated to be notified of a future splash pass when available). In an embodiment, the user component 106 can further employ the Splashtag feature when a splash loop is completed. For instance, the user component 106 can provide a primary pass and/or a secondary pass. In another embodiment, the user component can be configured to communicate media (e.g., pictures, images, video, among others) from a user to a merchant via a Splashtag, wherein the media relates to a good or service the merchant provides. The merchant can utilize the media communicated as a source to create a splash pass for users or the particular user (e.g., whether the user is a brand ambassador, a follower, has a relationship or subscription, and the like).

Splash Loop

A splash loop can include a set number of people that are required to redeem a splash pass based upon a merchant restriction or requirement. For instance, a set number can be any suitable positive integer. As an example, the set number can be five (5), wherein this set number can be referred to as the ‘Fab-5’ splash loop and all 5 of the Fab-5 loop unlock a bonus secondary pass made available by the merchant for the brand ambassador who completed the splash loop.

The splash loop can provide at least one of the following: a game-ifying of the redemption of splash passes by friends or networks (e.g., relationships, connections, etc.) which can provide social deal redemption; friends can invite other friends to come along and redeem a pass to close a splash loop; Splashtagss can provide the merchant to allow at least one of the one of the Fab-5 to create their own splash pass and share it with a limited set of friends. The Splashtag provides at least one of the following: the Fab-5 unlocks bonus pass; each of the Fab-5 can click a picture of an item that's available for a bonus pass (e.g., configured by merchant along with discount parameters and/or restrictions, among others), and splash the user splashes to a limited set of number of friends and/or connections and/or relationships (e.g., a restricted number can be a positive integer, for instance, to five connections); or can be claimed and redeemed by user and set of friends they share with.

Business Analytics Based on Splash

The business analytics component 202 can provide analysis and data related to a splash pass, a splash of a splash pass, redemption of a splash pass, a success rate of a type of splash pass (e.g., success being redeemed), the specific item or service for the splash pass, criteria used for a splash pass, tracking of use of splash passes, data related to users or brand ambassadors that consume or use the splash pass, data related to splashers (e.g., users that communicate the splash pass), data related to users of a splash pass, among others.

The business analytics component 202 can provide a set of real-time and over a period of time report or data that a merchant can use to monitor a splash pass or campaign of one or more splash passes and execution thereof. The business analytics component 202 can further enable the merchant to gain key insights from current splash pass or splash pass campaigns for future promotions. The business analytics component 202 can receive a query from a merchant on one or more splash pass campaigns or distributions of a splash pass and a report can be generated (e.g., available to the merchant via the device 104, a website, an email, a periodically and automatically communicated email, among others). By way of example, a real-time insight can be at least one of, but not limited to, splash pass metrics (e.g., a number of splash passes that are claimed, unclaimed, redeemed, and/or yet to be splashed); top brand ambassadors for the splash pass and/or splash pass campaign; splash pass campaign reach (e.g., new customers gained, repeat redeemers, first-time redeemers, etc.). By way of example reports across splash pass campaigns executed to date can include at least one of, but not limited to, first-time (e.g., new) customers; ambassador growth (e.g., based on new ambassadors recruited, among others); or top brand ambassadors (e.g., across all splash pass campaigns, among others).

In an aspect, incorporated is an APPENDIX A (attached). APPENDIX A is a document that describes aspects of the claimed subject matter, and this Appendix forms part of this specification.

In an aspect, incorporated is an APPENDIX B (attached). APPENDIX B is a document that describes aspects of the claimed subject matter, and this Appendix forms part of this specification. APPENDIX B illustrates screen shots that can be used with a device to implement the subject innovation. It is to be appreciated that the screen shots in APPENDIX B are solely for example and not to be limiting on the subject innovation. Moreover, any suitable screen shots can be generated in accordance with the subject innovation to provide the components and/or functionality described herein.

The aforementioned systems, components, (e.g., merchant component 102, the user component 106, the business analytics component 202, devices, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

In view of the exemplary devices and elements described supra, methodologies that may be implemented in accordance with the disclosed subject matter will be better appreciated with reference to the flow charts of FIGS. 5 and 6. The methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter. The methodologies can be implemented by a component or a portion of a component that includes at least a processor, a memory, and an instruction stored on the memory for the processor to execute.

FIG. 5 illustrates a flow chart of a method 500 for receiving a splash pass. At reference numeral 510, a relationship between a user and a merchant can be established via at least one of a request or an existing relationship of the user from at least one social network. At reference numeral 520, an offer from the merchant can be received based upon the established relationship. At reference numeral 530, the offer can be communicated to one or more relationships of the user. At reference numeral 540, an additional offer from the merchant can be received based upon one or more redemptions of the offer communicated to the one or more relationships of the user.

FIG. 6 illustrates a flow chart of a method 600 for communicating a splash pass. At reference numeral 610, a request can be accepted to establish a relationship with a user via at least one of an automatic acceptance from a relationship between the user and a merchant or a direct request from a user to the merchant. At reference numeral 620, an offer from the merchant can be communicated to the user based upon the accepted relationship. At reference numeral 630, a communication of the offer from the user can be monitored. At reference numeral 640, a number of redemptions from at least one of the user or the one or more relationships of the user can be tracked. At reference numeral 650, an additional offer can be communicated from the merchant exclusive to the user based upon the tracked number of redemptions.

In an embodiment, the media is at least one of a photo or an image from a device of the merchant. In an embodiment, the device of the merchant is at least one of a tablet, a smartphone, a cellphone, a portable gaming device, an Internet browsing device, a computer, or a laptop. In an embodiment, the media is at least one of a photo shared by one or more users. In an embodiment, the method can include establishing a relationship between the user and the merchant via at least one of a request or an existing relationship of the user from at least one social network. In an embodiment, the method can include creating the offer that includes a contribution of media from one or more users.

In an embodiment, a method can be provided that at least includes the following steps: receiving an incentive from a provider; identifying an ambassador relationship between the provider and an ambassador user; transmitting the incentive to the ambassador user; receiving an incentive action from a prospect user, the prospect user shares at least a prospect relationship with the ambassador user; and crediting an ambassador score associated with the ambassador user based at least in part on the incentive action.

In an embodiment, the method can further include establishing a new ambassador relationship between a new user and the provider and/or identifying the new user as the ambassador user. In an embodiment, the method can include creating the offer that includes a contribution of media from one or more users, wherein the contribution of media from one or more uses includes a hashtag from the one or more users to identify the merchant. In an embodiment, the method can further include receiving a bonus from the provider and/or transmitting the bonus to the ambassador user based at least in part on the ambassador score. In an embodiment, the method can include determining one or more locations of at least one of the provider, the ambassador user, and the prospect user. In an embodiment, the incentive is based at least in part on the one or more locations. In an embodiment, the provider is distinct from an entity that honors the incentive. In an embodiment, the method can further include associating a tag to a portion of media, wherein the tag signifies the portion of media to the provider. In an embodiment, the method can further include communicating the tag and the portion of media to a website. In an embodiment, the method can further include identifying one or more portions of media for the provider from the website based on the tag and utilizing the one or more portions of media for an additional incentive for one or more ambassador users.

In the specification and clauses, reference will be made to a number of terms that have the following meanings. The singular forms “a”, “an” and “the” include plural referents unless the context clearly dictates otherwise. Approximating language, as used herein throughout the specification and clauses, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the clauses, and may include other examples that occur to one of ordinary skill in the art. Such other examples are intended to be within the scope of the clauses if they have structural elements that do not differentiate from the literal language of the clauses, or if they include equivalent structural elements with insubstantial differences from the literal language of the clauses.

What is claimed is:

1. A method, comprising:
establishing a relationship between a user and a merchant via at least one of a request or an existing relationship of the user from at least one social network;
receiving an offer from the merchant based upon the established relationship;
communicating the offer to one or more relationships of the user;
receiving an additional offer from the merchant based upon one or more redemptions of the offer communicated to the one or more relationships of the user.

2. The method of claim 1, wherein the merchant is an establishment that sells food.

3. A method, comprising:
accepting a request to establish a relationship with a user via at least one of an automatic acceptance from a relationship between the user and a merchant or a direct request from a user to the merchant;
communicating an offer from the merchant to the user based upon the accepted relationship;
monitoring a communication of the offer from the user;
tracking a number of redemptions from at least one of the user or the one or more relationships of the user; and
communicating an additional offer from the merchant exclusive to the user based upon the tracked number of redemptions.

4. The method of claim 3, wherein the merchant is a restaurant that sells a food item.

5. A method comprising:
creating an offer from a merchant based on media;
communicating the offer to one or more users;
associating a reward to the offer, wherein the reward relates to the merchant; and
communicating the reward to at least one user based on redemption, wherein the communication is a user that redeemed the offer or an additional user that has an established relationship on a social network.

6. The method of claim 5, wherein the merchant is an entity that sells food.

7. The method of claim 6, wherein the media is at least one of a photo or an image from a device of the merchant.

8. The method of claim 7, wherein the device of the merchant is at least one of a tablet, a smartphone, a cellphone, a portable gaming device, an Internet browsing device, a computer, or a laptop.

9. The method of claim 6, wherein the media is at least one of a photo shared by one or more users.

10. The method of claim 6, further comprising establishing a relationship between the user and the merchant via at least one of a request or an existing relationship of the user from at least one social network.

11. The method of claim 6, further comprising creating the offer that includes a contribution of media from one or more users, wherein the contribution of media from one or more uses includes a hashtag from the one or more users to identify the merchant.

12. A method, comprising:
receiving an incentive from a provider, wherein the provider is a restaurant;
identifying an ambassador relationship between the provider and an ambassador user;
transmitting the incentive to the ambassador user;
receiving an incentive action from a prospect user, the prospect user shares at least a prospect relationship with the ambassador user; and
crediting an ambassador score associated with the ambassador user based at least in part on the incentive action.

13. The method of claim 12, further comprising:
establishing a new ambassador relationship between a new user and the provider; and
identifying the new user as the ambassador user.

14. The method of claim 12, further comprising:
receiving a bonus from the provider; and
transmitting the bonus to the ambassador user based at least in part on the ambassador score.

15. The method of claim 12, further comprising determining one or more locations of at least one of the provider, the ambassador user, and the prospect user.

16. The method of claim 15, the incentive is based at least in part on the one or more locations.

17. The method of claim 12, the provider is distinct from an entity that honors the incentive.

18. The method of claim 12, further comprising associating a tag to a portion of media, wherein the tag signifies the portion of media to the provider.

19. The method of claim 18, further comprising communicating the tag and the portion of media to a website.

20. The method of claim 19, further comprising:
identifying one or more portions of media for the provider from the website based on the tag;
utilizing the one or more portions of media for an additional incentive for one or more ambassador users.
